(19) United States
(12) Patent Application Publication
(10) Pub. No.: US 2016/0127653 A1
(43) Pub. Date: May 5, 2016

(54) Electronic Device and Method for Providing Filter in Electronic Device

(71) Applicant: Samsung Electronics Co., Ltd., Suwon-si (KR)

(72) Inventors: Jun-Ho Lee, Suwon-si (KR); Gong-Wook Lee, Suwon-si (KR); Jin-He Jung, Suwon-si (KR); Ik-Hwan Cho, Suwon-si (KR)

(21) Appl. No.: 14/930,940

(22) Filed: Nov. 3, 2015

(30) Foreign Application Priority Data
Nov. 3, 2014 (KR) 10-2014-0151302

(51) Int. Cl. H04N 5/232; H04N 5/225

(52) U.S. Cl. CPC H04N 5/23293; H04N 5/2254

(57) ABSTRACT

An electronic device includes a screen of a display; an image sensor configured to capture image data having at least one object; and a filter recommendation control module configured to acquire the image data captured by the image sensor, extract at least one filter data based on the at least one object of the image data, and display the at least one or more filter data on the screen in response to request information.

### CROSS-REFERENCE TO RELATED APPLICATION(S)

This application claims the benefit under 35 U.S.C. §119(a) of a Korean patent application filed in the Korean Intellectual Property Office on Nov. 3, 2014 and assigned Serial No. 10-2014-0151302, the entire disclosure of which is incorporated herein by reference.

### TECHNICAL FIELD

Various embodiments of the present disclosure relate to an electronic device and a method for providing a filter in the electronic device.

### BACKGROUND

A filter function among a variety of functions capable of editing photos is a function capable of creating a photo of a special feeling by applying a variety of effects to the photo. If one filter function is selected for one photo, the same effect corresponding to the selected filter function may be applied to the whole photo.

Since the same effect corresponding to the selected filter function is applied to the whole photo, it is not possible to apply another filter function desired by the user depending on the types of various objects included in the photo, or to apply a filter function desired by the user only to the object desired by the user among the various objects included in the photo.

The above information is presented as background information only to assist with an understanding of the present disclosure. No determination has been made, and no assertion is made, as to whether any of the above might be applicable as prior art with regard to the present disclosure.

### SUMMARY

An aspect of various embodiments of the present disclosure is to address at least the above-mentioned problems and/or disadvantages and to provide at least the advantages described below. Accordingly, an aspect of various embodiments of the present disclosure is to provide an electronic device capable of providing a variety of filter functions depending on the type of an object included in image data, and a method for providing a filter in the electronic device.

In accordance with an aspect of the present disclosure, there is provided an electronic device that includes an image sensor; and a filter recommendation control module configured to acquire image data captured by the image sensor, extract at least one filter data based on an object of the image data, and display the at least one filter data on a screen in response to request information.

In accordance with another aspect of the present disclosure, there is provided an electronic device that includes a storage module storing at least one filter data corresponding to filter data request information including at least one of shooting information and object information; and a filter recommendation control module configured to, if at least one filter data request information is received from another electronic device, extract at least one filter data based on at least one of shooting information and object information included in at least one filter data, and transmit the extracted at least one filter data to another electronic device.

In accordance with further another aspect of the present disclosure, there is provided a method for providing a filter in an electronic device. The method includes acquiring image data captured by an image sensor; extracting at least one filter data based on an object of the image data; and displaying the at least one filter data on a screen in response to request information.

In accordance with yet another aspect of the present disclosure, there is provided a method for providing a filter in an electronic device. The method includes storing at least one filter data corresponding to filter data request information including at least one of shooting information and object information; and if at least one filter data request information is received from another electronic device, extracting at least one filter data based on at least one of shooting information and object information included in at least one filter data, and transmitting the extracted at least one filter data to another electronic device.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features and advantages of certain exemplary embodiments of the present disclosure will be more apparent from the following description taken in conjunction with the accompanying drawings, in which:

FIG. 1 is a block diagram illustrating an electronic device according to various embodiments of the present disclosure;

FIG. 2 is a block diagram illustrating an electronic device for providing a filter according to various embodiments of the present disclosure;

FIG. 3 is a flowchart illustrating a method for providing a filter according to various embodiments of the present disclosure;

FIG. 4 is a flowchart illustrating a method for providing a filter according to various embodiments of the present disclosure;

FIG. 5 illustrates an operation of providing a filter on a video according to various embodiments of the present disclosure;

FIG. 6 illustrates an operation of providing a filter on a still image according to various embodiments of the present disclosure;

FIG. 7 illustrates an operation of providing detailed information about an object in image data according to various embodiments of the present disclosure;

FIG. 8 illustrates an operation of providing detailed information about an object in image data according to various embodiments of the present disclosure;

FIG. 9 illustrates an operation of providing detailed information about an object in image data according to various embodiments of the present disclosure; and

FIG. 10 is a block diagram illustrating an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to the present disclosure may be a device with a display function. For example, the electronic device may include a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, a wearable device (e.g., a Head Mounted Device (HMD) (such as electronic glasses), electronic apparel, electronic bracelet, electronic necklace, appcessory, or smart watch), and/or the like.

In some embodiments, the electronic device may be a smart home appliance with a display function. The smart home appliance may include at least one of, for example, a television (TV), a Digital Video Disk (DVD) player, an audio set, a refrigerator, an air conditioner, a cleaner, an oven, a microwave oven, a washer, an air purifier, a set-top box, a TV box (e.g., Samsung HomeSync™, Apple TV™, or Google TV™), a game console, an electronic dictionary, an electronic key, a camcorder, and an electronic photo frame.

In some embodiments, the electronic device may include at least one of various medical devices (e.g., Magnetic Resonance Angiography (MRA), Magnetic Resonance Imaging (MRI), Computed Tomography (CT), a medical camcorder, an ultrasound device and/or the like), a navigation device, a Global Positioning System (GPS) receiver, a Event Data Recorder (EDR), a Flight Data Recorder (FDR), an automotive infotainment device, a marine electronic device (e.g., a marine navigation system, a gyro compass and the like), avionics, and a security device.

In some embodiments, the electronic device may include at least one of part of furniture or building/structure, an electronic board, an electronic signature receiving device, a projector, and various meters (e.g., water, electricity, gas or radio meters), each of which includes a display function. The electronic device according to the present disclosure may be one of the above-described various devices, or a combination of at least two of them. It will be apparent to those skilled in the art that the electronic device according to the present disclosure is not limited to the above-described devices.

The electronic device according to various embodiments of the present disclosure will be described below with reference to the accompanying drawings. The term ‘user’ as used herein may refer to a person who uses the electronic device, or a device (e.g., an intelligent electronic device) that uses the electronic device.

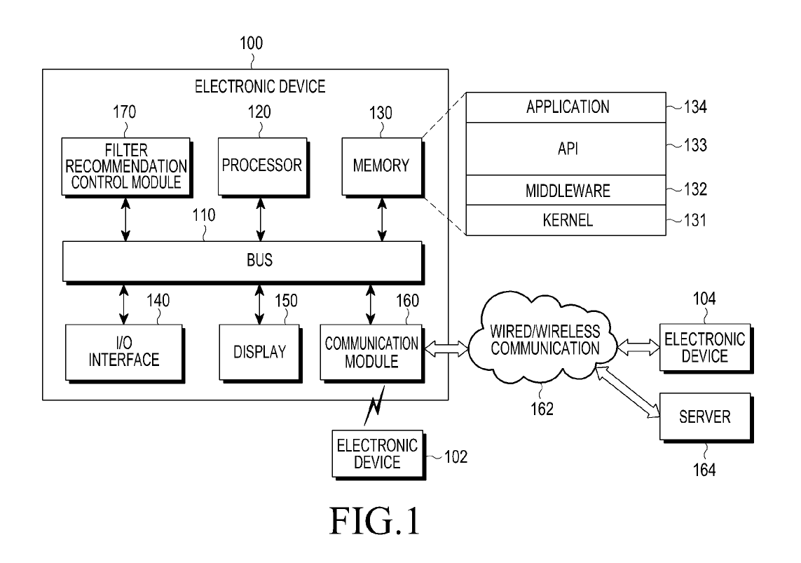

FIG. 1 is a block diagram illustrating an electronic device according to various embodiments of the present disclosure. Referring to FIG. 1, an electronic device 100 may include a bus 110, a processor 120, a memory 130, an Input/Output (I/O) interface 140, a display 150, a communication module 160, or a filter recommendation control module 170.

The bus 110 may be a circuit for connecting the above-described components to one another, and delivering communication information (e.g., a control message) between the above-described components.

The processor 120 may receive a command from the above-described other components (e.g., the memory 130, the I/O interface 140, the display 150, the communication module 160 and/or the like) through the bus 110, decrypt the received command, and perform data operation or data processing in response to the decrypted command.

The memory 130 may store the command or data that is received from or generated by the processor 120 or other components (e.g., the I/O interface 140, the display 150, the communication module 160 and/or the like). The memory 130 may include programming modules such as, for example, a kernel 131, a middleware 132, an Application Programming Interface (API) 133, at least one application 134, and/or the like. Each of the above-described programming modules may be configured by software, firmware, hardware or a combination of at least two of them.

The kernel 131 may control or manage the system resources (e.g., the bus 110, the processor 120, the memory 130 and/or the like) that are used to perform the operation or function implemented in the other programming modules (e.g., the middleware 132, the API 133 or the application 134). In addition, the kernel 131 may provide an interface by which the middleware 132, the API 133 or the application 134 can access individual components of the electronic device 100 to control or manage them.

The middleware 132 may play a relay role so that the API 133 or the application 134 may exchange data with the kernel 131 by communicating with the kernel 131. In addition, the middleware 132 may perform load balancing in response to work requests received from the multiple applications 134 by using, for example, a method such as assigning a priority capable of using the system resources (e.g., the bus 110, the processor 120, the memory 130 and/or the like) of the electronic device 100, to at least one of the multiple applications 134.

The API 133 may include at least one interface or function for, for example, file control, window control, image processing, character control and/or the like, as an interface by which the application 134 can control the function provided by the kernel 131 or the middleware 132.

The I/O interface 140 may, for example, receive a command or data from the user, and deliver the command or data to the processor 120 or the memory 130 through the bus 110. The display 150 may display video, image or data (e.g., multimedia data, text data, and/or the like), for the user.

The communication module 160 may connect communication between the electronic device 100 and other electronic devices 102 and 104, or a server 164. The communication module 160 may support wired/wireless communication 162 such as predetermined short-range wired/wireless communication (e.g., Wireless Fidelity (WiFi), Bluetooth (BT), Near Field Communication (NFC), network communication (e.g., Internet, Local Area Network (LAN), Wide Area Network (WAN), telecommunication network, cellular network, or satellite network), Universal Serial Bus (USB), Recommended Standard 232 (RS-232), Plain Old Telephone Service (POTS), and/or the like). Each of the electronic devices 102 and 104 may be the same device (e.g., a device in the same type) as the electronic device 100, or a different device (e.g., a device in a different type) from the electronic device 100.

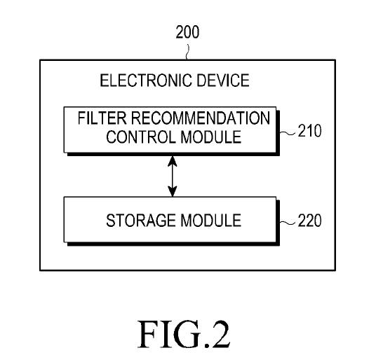

The filter recommendation control module 170 may provide at least one filter data based on at least one object of image data. In connection with FIGS. 2 to 10, additional information on the filter recommendation control module 170 may be provided.

FIG. 2 is a block diagram illustrating an electronic device 200 for transmission control according to various embodiments of the present disclosure. The electronic device 200 may be, for example, the electronic device 100 shown in FIG. 1. Referring to FIG. 2, the electronic device 200 may include a filter recommendation control module 210 and a storage module 220.

According to one embodiment, the filter recommendation control module 210 may be the filter recommendation control module 170 shown in FIG. 1. According to one embodiment, the filter recommendation control module 210 may be the processor 120 shown in FIG. 1. The filter recommendation control module 210 may include, for example, one of hardware, software or firmware, or a combination of at least two of them.

According to one embodiment, if filter recommendation is selected by the user while displaying image data, the filter recommendation control module 210 may detect filter data request information including at least one of shooting information and object information from the image data. While displaying image data stored in the storage module 220, the filter recommendation control module 210 may detect filter data request information in response to selection of filter recommendation. The filter recommendation control module 210 may detect filter data request information in response to selection of filter recommendation in a preview mode for displaying image data received through a camera module.

The filter recommendation control module 210 may detect shooting information from, for example, Exchangeable Image File Format (EXIF) information (e.g., camera manufacturer, camera model, direction of rotation, date and time, color space, focal length, flash, ISO speed rating, iris, shutter speed, GPS information, and/or the like) that is included in image data. The shooting information may also include at least one of, for example, a shooting location, a shooting weather, a shooting date, and a shooting time, and other information (e.g., the EXIF information) that is included in image data. While displaying image data in the preview mode, the filter recommendation control module 210 may detect the current location information received through GPS as the shooting location, the current weather information provided from an external electronic device (e.g., a weather server) as the shooting weather, and the current date and current time as the shooting date and shooting time.

The filter recommendation control module 210 may detect object information including at least one of a type of an object, a location of an object, a proportion of an object, and a sharpness of an object, from image data, and the number of object information may correspond to the number of objects included in image data. The filter recommendation control module 210 may use the known object recognition technique to detect a type of an object included in the image data, a location of an object in the image data, a proportion of an object in the image data, and a sharpness of an object in the image data.

The filter recommendation control module 210 may detect classification information for each of at least one object included in image data based on the object information, and the classification information may be determined according to a priority of a location of an object, a proportion of an object, and a sharpness of an object. Filter data may be provided differently according to the classification information of each of at least one object included in image data. The filter recommendation control module 210 may detect a shooting location based on the shooting information, or may detect a shooting location and a shooting weather based on the shooting information. If the shooting information includes no shooting weather, the filter recommendation control module 210 may receive, as shooting weather, the weather information corresponding to the shooting location, shooting date and shooting time from the external electronic devices 102, 104, or the server 164 (e.g., a weather server).

The filter recommendation control module 210 may detect at least one filter data corresponding to the shooting location or the classification information of at least one object, from a filter database (DB) of the storage module 220. The filter recommendation control module 210 may detect at least one filter data corresponding to the shooting location, the shooting weather or the classification information of at least one object, from the filter DB of the storage module 220. While displaying image data, the filter recommendation control module 210 may display at least one filter data for each object included in the image data. If filter data is selected while displaying at least one filter data for each object included in the image data, the filter recommendation control module 210 may apply a filter function corresponding to the selected filter data to the object, and update the filter data for the object in the filter DB of the storage module 220. Upon receiving the filter data selected by the user, the filter recommendation control module 210 may learn the filter data for the object and store the learned filter data in the filter DB of the storage module 220, based on at least one of the classification information (e.g., a location of an object, a proportion of an object, and a sharpness of an object) and the shooting location (and the shooting weather) for the object. For example, in a photo of two persons, which was taken in the Han river on a clear autumn day, filter data for the persons, river, and background, which is suitable for the taken photo, may be learned by the user's selection, so high-similarity filter data may be provided according to each object. The filter recommendation control module 210 may receive the filter data for each object, which was learned by selections of several people, from another electronic device (e.g., a filter data server) periodically or at the request of the user.

According to one embodiment, the filter recommendation control module 210 may transmit the filter data request information detected from the image data to another electronic device (e.g., the filter data server). Another electronic device may be, for example, the electronic devices 102 and 104 or the server 164 shown in FIG. 1. Upon receiving filter data from another electronic device, the filter recommendation control module 210 may display at least one filter data received for each of at least one object while displaying the image data. If filter data is selected while displaying at least one filter data for each object included in the image data, the filter recommendation control module 210 may apply a filter function corresponding to the selected filter data to the object, and transmit the selected filter data so that another electronic device can update the filter data for the object.

According to one embodiment, upon receiving filter data request information from another electronic device, the filter recommendation control module 210 may detect at least one filter data from the filter DB of the storage module 220 based on the received filter data request information, and transmit the detected filter data to another electronic device. Upon receiving filter data selected by the user from another electronic device, the filter recommendation control module 210 may learn the filter data for the object and store the learned filter data in the filter DB of the storage module 220.

According to one embodiment, if detailed information about an object is requested while displaying image data, the filter recommendation control module 210 may display the detailed information about the object, which is received from an external electronic device. For example, the filter recommendation control module 210 may receive, from the external electronic device, not only the filter data for foods photographed or captured in a restaurant, but also detailed information (e.g., food names, food calories and/or the like) about the photographed foods.

The storage module 220 may be, for example, the memory 130 shown in FIG. 1. According to one embodiment, the storage module 220 may store at least one filter data including at least one of object information and shooting information.

According to various embodiments, a screen of a display; an image sensor (not shown) configured to capture image data having at least one object and the filter recommendation control module 210 may be configured to acquire image data captured by the image sensor, extract at least one or more filter data based on an object of the image data, and display the at least one filter data on a screen in response to request information.

According to various embodiments, the image data may include at least one of shooting information and object information.

According to various embodiments, the shooting information may include at least one of a shooting location, a shooting weather, a shooting date, and a shooting time.

According to various embodiments, the object information may include at least one of a type of an object, a location of an object, a proportion of an object, and a sharpness of an object, and the object information may be configured to be present to correspond to the number of at least one object included in the image data.

According to various embodiments, the filter recommendation control module 210 may be configured to extract an object from the image data by defining an area.

According to various embodiments, the filter recommendation control module 210 may be configured to extract the filter data, extract a shooting location based on shooting information of the image data, and extract at least one filter data corresponding to at least one of a shooting location and classification information of an object, from a filter DB.

According to various embodiments, the filter recommendation control module 210 may be configured to determine the classification information of an object for each of at least one object included in the image data depending on at least one of a priority of a location of an object, a proportion of an object, and a sharpness of an object.

According to various embodiments, the filter recommendation control module 210 may be configured to, if at least one filter data is selected while displaying at least one filter data, apply a filter function corresponding to at least one filter data to each of at least one object and update filter data of an object corresponding to the selected at least one filter data.

According to various embodiments, the filter recommendation control module 210 may be configured to extract at least one of shooting information and object information from the image data as filter data request information, transmit the extracted filter data request information to another electronic device, provide at least one filter data received from another electronic device as at least one filter information for each of at least one object included in the image data, and transmit filter data of an object corresponding to selected filter data to another electronic device.

According to various embodiments, the storage module 220 may store at least one filter data corresponding to filter data request information including at least one of shooting information and object information, and the filter recommendation control module 210 may be configured to, if at least one filter data request information is received from another electronic device, extract at least one filter data based on at least one of shooting information and object information included in at least one filter data, and transmit the extracted at least one filter data to another electronic device.

According to various embodiments, the filter recommendation control module 210 may be configured to extract classification information for each of at least one object included in image data based on the object information, extract a shooting location based on the shooting information, and extract at least one filter data corresponding to at least one of a shooting location and classification information of an object, from a stored filter DB.

According to various embodiments, the filter recommendation control module 210 may be configured to determine the classification information of an object for each of at least one object included in the image data depending on at least one of a priority of a location of an object, a proportion of an object, and a sharpness of an object.

According to various embodiments, the filter recommendation control module 210 may be configured to, if selected filter data is received from another electronic device, update filter data of an object corresponding to the selected filter data.

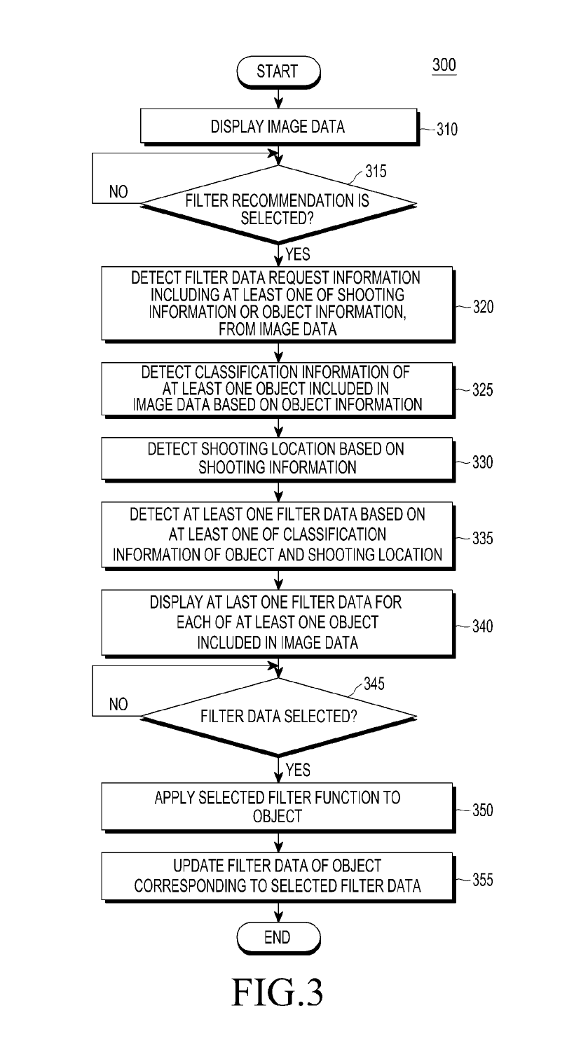

FIG. 3 is a flowchart illustrating a method for providing a filter according to various embodiments of the present disclosure. Referring to FIG. 3, a filter recommendation control method 300 according to various embodiments of the present disclosure may include operation 310 to operation 355. In operation 310, the filter recommendation control module 210 may display image data. The image data displayed in operation 310 may be image data selected by the user among the image data stored in the storage module 220 or image data received in the preview mode. In operation 315, the filter recommendation control module 210 may determine whether filter recommendation is selected. If it is determined in operation 315 that filter recommendation is selected while the filter recommendation control module 210 displays the image data, the filter recommendation control module 210 may detect filter data request information including at least one of object information for each of objects included in the image data and shooting information of the image data in operation 320. In operation 325, the filter recommendation control module 210 may detect classification information (e.g., a location of an object, a proportion of an object, or a sharpness of an object) of at least one object for each of at least one object included in the image data based on the object information. In operation 330, the filter recommendation control module 210 may detect at least one of a shooting location (or a shooting place), and a shooting date (and a shooting weather) based on the shooting information. In operation 335, the filter recommendation control module 210 may detect at least one filter data for each of at least one object included in the image data from a filter DB of the storage module 220 based on at least one of the detected shooting location (or shooting place), shooting date (and shooting weather), and the classification information of at least one object. In operation 340, the filter recommendation control module 210 may display at least one filter data for each of at least one object included in the image data, while displaying the image data. In operation 345, the filter recommendation control module 210 may determine whether filter data is selected from among at least one filter data for each of at least one object. If it is determined in operation 345 that filter data is selected, the filter recommendation control module 210 may apply a filter function corresponding to the selected filter data to the object in operation 350. In operation 355, the filter recommendation control module 210 may learn the filter data for the object depending on the selected filter data, and update the filter data for the object in the filter DB of the storage module 220 by reflecting the learning results.

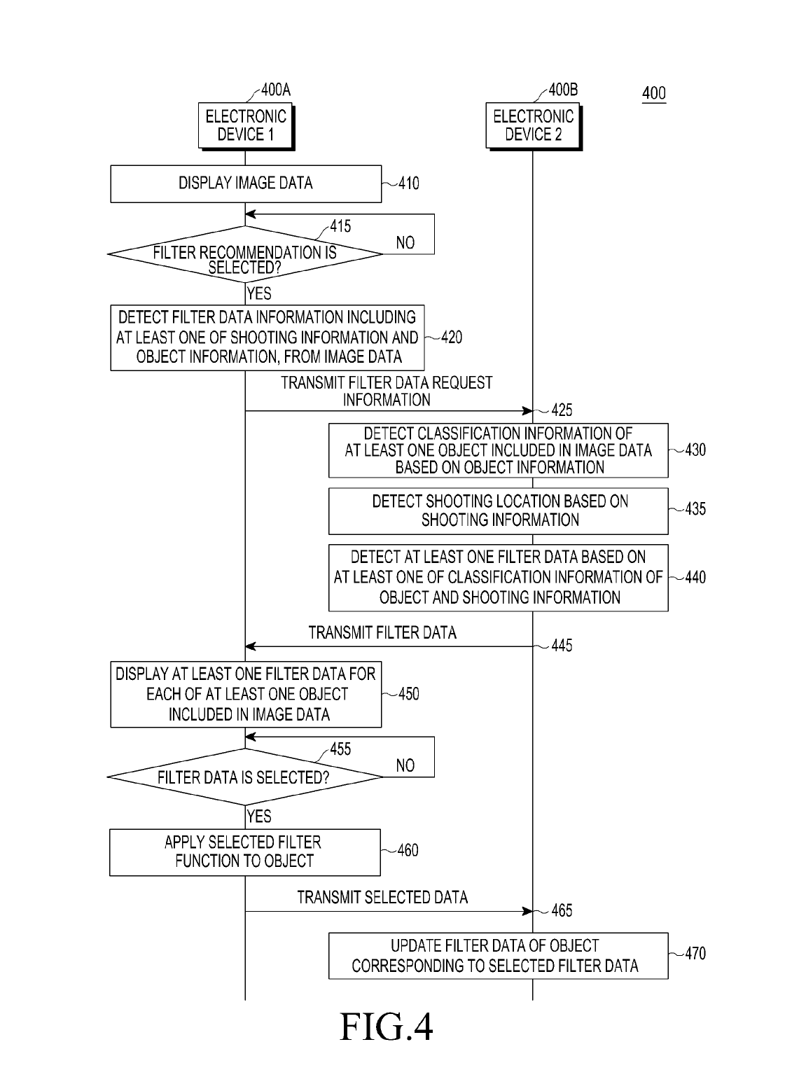

FIG. 4 is a flowchart illustrating a method for providing a filter according to various embodiments of the present disclosure. Referring to FIG. 4, a filter recommendation control method 400 according to various embodiments of the present disclosure may include operation 410 to operation 470. A first electronic device 400A and a second electronic device 400B may be the electronic device 100 in FIG. 1 and the electronic device 200 in FIG. 2, respectively. Alternatively, the second electronic device 400B may be the server 164 in FIG. 1, and the server 164 may include a filter recommendation control module having the same function as that of the filter recommendation control module 170 of the electronic device 100 in FIG. 1 and the filter recommendation control module 210 of the electronic device 200 in FIG. 2. In operation 410, the first electronic device 400A (e.g., a filter recommendation control module capable of performing the same function as that of the filter recommendation control module 210 of the electronic device 200 in FIG. 2) may display image data. The image data displayed in operation 410 may be image data selected by the user among the image data stored in the storage module 220 or image data received in the preview mode. In operation 415, the first electronic device 400A may determine whether filter recommendation is selected. If it is determined in operation 415 that filter recommendation is selected while the first electronic device 400A displays the image data, the first electronic device 400A may detect filter data request information including at least one of object information for each of objects included in the image data, and shooting information of the image data in operation 420. In operation 425, the first electronic device 400A may transmit the filter data request information to the second electronic device 400B. In operation 430, the second electronic device 400B (e.g., a filter recommendation control module capable of performing the same function as that of the filter recommendation control module 210 of the electronic device 200 in FIG. 2) may detect classification information (e.g., a location of an object, a proportion of an object, or a sharpness of an object) of at least one object for each of at least one object included in the image data based on the object information included in the filter data request information received from the first electronic device 400A. In operation 435, the second electronic device 400B may detect at least one of a shooting location (or a shooting place), and a shooting date (and a shooting weather) based on the shooting information included in the filter data request information. In operation 440, the second electronic device 400B may detect at least one filter data for each of at least one object included in the image data from a filter DB of the storage module 220 of the second electronic device 400B based on at least one of the detected shooting location (or shooting place), shooting date (and shooting weather), and the classification information of at least one object. In operation 445, the second electronic device 400B may transmit the detected at least one filter data to the first electronic device 400A. In operation 450, while displaying the image data, the first electronic device 400A may receive at least one filter data for each of at least one object included in the image data from the second electronic device 400B, and display the received filter data. In operation 455, the first electronic device 400A may determine whether filter data is selected from among at least one filter data for each of at least one object. If it is determined in operation 455 that filter data is selected, the first electronic device 400A may apply a filter function corresponding to the selected filter data to the object in operation 460. In operation 465, the first electronic device 400A may transmit the selected filter data to the second electronic device 400B. In operation 470, the second electronic device 400B may learn the filter data for the object depending on the selected filter data received from the first electronic device 400A, and update the filter data for the object in the filter DB of the storage module 220 of the second electronic device 400B by reflecting the learning results.

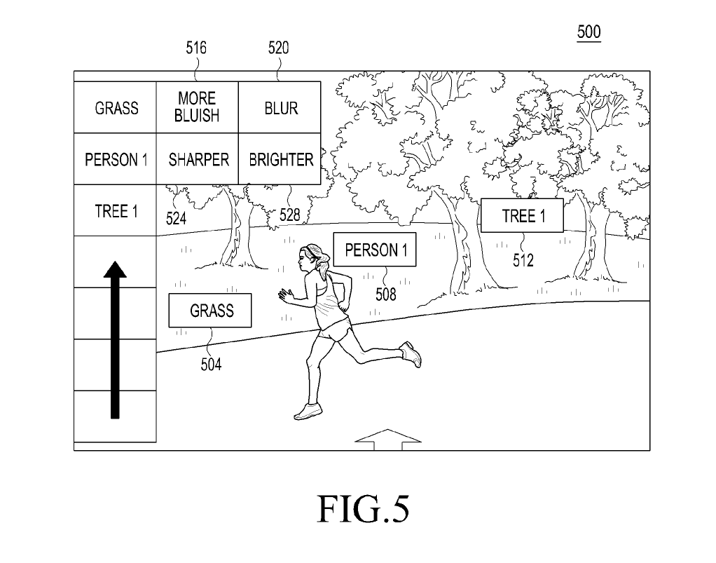

FIG. 5 illustrates an operation of providing a filter on a video 500 according to various embodiments of the present disclosure. Referring to FIG. 5, in the case of a video in image data, since its object information (e.g., a type of an object, a location of an object, a proportion of an object, or a sharpness of an object) may be changed in every frame, it is possible to detect the changed object information in every frame, and display at least one filter data corresponding to each object. As shown in FIG. 5, the filter recommendation control module 210 (of FIG. 2) may detect, as filter data request information, at least one of three object information (e.g., a type of an object, a location of an object, a proportion of an object, and a sharpness of an object) corresponding to three objects such as ‘grass’ 504, ‘person 1’ 508, and ‘tree 1’ 512 included in a specific frame of the video, or shooting information of the video. The filter recommendation control module 210 may detect classification information (e.g., a location of an object, a proportion of an object, or a sharpness of an object) of an object for each object based on each object information and detect a shooting location (and a shooting weather) based on the shooting information of the video. The filter recommendation control module 210 may detect filter data corresponding to at least one of the detected shooting location (and shooting weather), and the detected classification information of an object for each object, from a filter DB of the storage module 220 (of FIG. 2). The filter recommendation control module 210 may transmit the filter data request information to another electronic device, and then receive at least one filter data for each of the three objects from another electronic device. As shown in FIG. 5, the filter recommendation control module 210 may display ‘more bluish’ 516 and ‘blur’ 520 as filter data for an object of ‘grass’ 504, and display ‘sharper’ 524 and ‘brighter’ 528 as filter data for an object of ‘person 1’ 508. If no filter data is displayed for ‘tree 1’ 512 as shown in FIG. 5, the filter recommendation control module 210 may allow the user to select filter information manually.

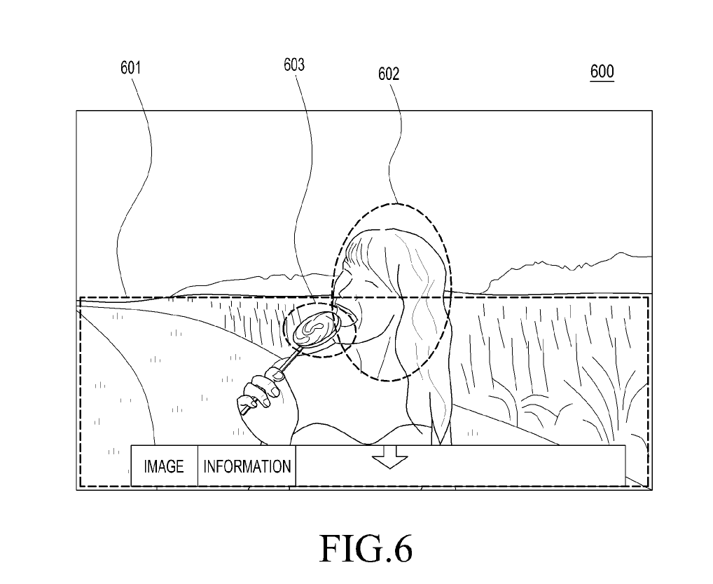

FIG. 6 illustrates an operation of providing a filter on a still image 600 according to various embodiments of the present disclosure. In FIG. 6, the filter recommendation control module 210 (of FIG. 2) may detect and display filter data for each of three objects such as grass, person and candy included in a still image in image data. As shown in FIG. 6, the filter recommendation control module 210 may display ‘more bluish (clearly)’ and ‘blur (less focused)’ as filter data for an object 601 of ‘grass’, display ‘whitish’, ‘remove wrinkles’, ‘look younger’ and ‘clear cut profile’ as filter data for an object 602 of ‘person’, and display ‘in primary colors’, ‘look cold’ and ‘look warm’ as filter data for an object 603 of ‘candy’.

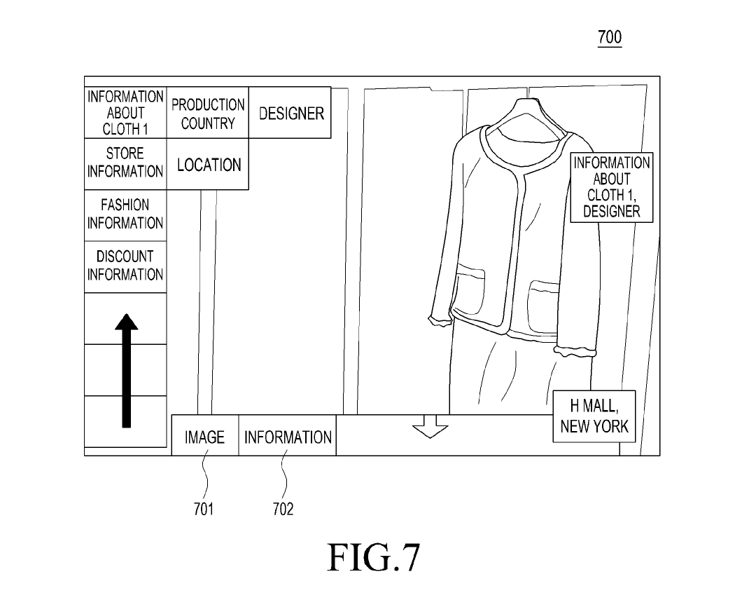

FIG. 7 illustrates an operation of providing detailed information about an object in image data 700 according to various embodiments of the present disclosure. In FIG. 7, while the electronic device 200 (of FIG. 2) is displaying image data that is received from or captured by a camera module (not shown) in a clothing store in a preview mode, the electronic device 200 may display at least one filter data for an object included in image data where ‘image’ 701 is selected. If ‘information’ 702 is selected, the electronic device 200 may receive detailed information about the object included in the image data from an external electronic device (e.g., the electronic devices 102, 104, or the server 164, of FIG. 1) and display the received detailed information as shown in FIG. 7.

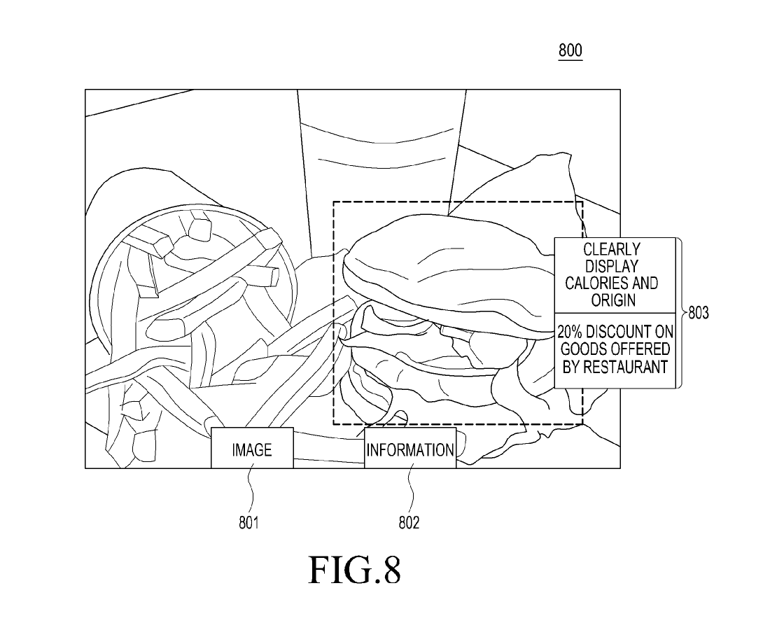

FIG. 8 illustrates an operation of providing detailed information about an object in image data 800 according to various embodiments of the present disclosure. In FIG. 8, while the electronic device 200 (of FIG. 2) is displaying image data that is received from or captured by a camera module (not shown) in a restaurant in the preview mode, the electronic device 200 may display at least one filter data for an object included in image data where ‘image’ 801 is selected. If ‘information’ 802 is selected, the electronic device 200 may receive detailed information 803 about the object included in the image data from an external electronic device and display the received detailed information as shown in FIG. 8.

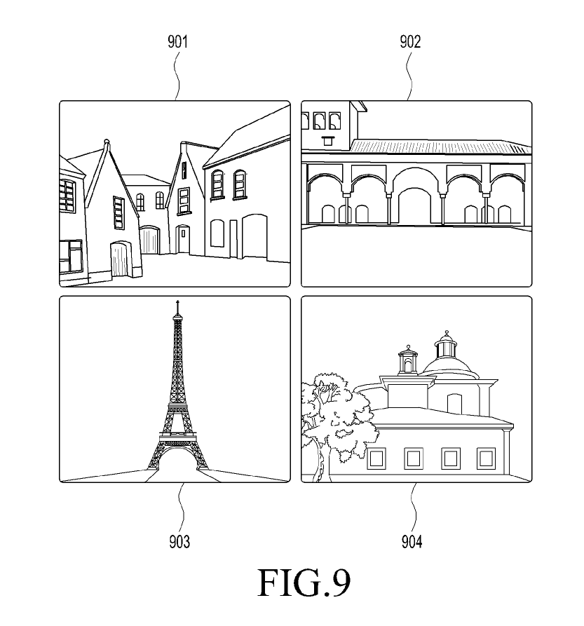

FIG. 9 illustrates an operation of providing detailed information about an object in image data according to various embodiments of the present disclosure. While the electronic device 200 (of FIG. 2) is displaying the image data 901, the filter recommendation control module 210 (of FIG. 2) may display at least one filter data for each of at least one object included in the image data 901. If the user applies a filter function to the image data 901 using the at least one filter data, the filter recommendation control module 210 may detect recommended places that may have at least one filter data similar to the at least one filter data provided to the image data 901, and display the detected recommended places as image data items 902 to 904, as shown in FIG. 9. The filter recommendation control module 210 may display the image data items 902 to 904 for the recommended places close to the location where the image data 901 was captured, among the detected recommended places, according to the user's priorities.

According to various embodiments, a method for providing a filter in an electronic device may include acquiring image data captured by an image sensor (not shown); extracting at least one or more filter data based on an object of the image data; and displaying the at least one filter data on a screen (not shown) in response to request information.

According to various embodiments, the image data may include at least one of shooting information and object information.

According to various embodiments, the shooting information may include at least one of a shooting location, a shooting weather, a shooting date, and a shooting time.

According to various embodiments, the object information may include at least one of a type of an object, a location of an object, a proportion of an object, and a sharpness of an object, and the object information is configured to be present to correspond to the number of at least one object included in the image data.

According to various embodiments, the extracting at least one filter data may include extracting an object from the image data by defining an area.

According to various embodiments, the extracting at least one or more filter data may include extracting a shooting location based on shooting information of the image data; and extracting at least one filter data corresponding to at least one of a shooting location, and classification information of an object, from a filter DB.

According to various embodiments, the extracting classification information may include determining the classification information of an object for each of at least one object included in the image data depending on at least one of a priority of a location of an object, a proportion of an object, and a sharpness of an object.

According to various embodiments, the method may further include, if at least one filter data is selected while displaying at least one filter data, applying a filter function corresponding to at least one filter data to each of at least one object, and updating filter data of an object corresponding to selected filter data.

According to various embodiments, the method may further include extracting at least one of shooting information and object information from the image data as filter data request information and transmitting the extracted filter data request information to another electronic device (similar to the electronic device 200 of FIG. 2, or the second electronic device 400B of FIG. 4); providing at least one filter data received from another electronic device as at least one filter information for each of at least one object included in the image data; and transmitting filter data of an object corresponding to selected filter data to another electronic device.

According to various embodiments, a method for providing a filter in an electronic device, the method may include storing at least one filter data corresponding to filter data request information including at least one of shooting information and object information; and if at least one filter data request information is received from another electronic device (similar to the electronic device 200 of FIG. 2, or the second electronic device 400B of FIG. 4), extracting at least one filter data based on at least one of shooting information and object information included in at least one filter data, and transmitting the extracted at least one filter data to t another electronic device.

According to various embodiments, the extracting at least one filter data may include extracting classification information for each of at least one object included in image data based on the object information; extracting a shooting location based on the shooting information; and extracting at least one filter data corresponding to at least one of a shooting location and classification information of an object, from a stored filter DB.

According to various embodiments, the extracting classification information may include determining the classification information of an object for each of at least one object included in the image data depending on at least one of a priority of a location of an object, a proportion of an object, and a sharpness of an object.

According to various embodiments, the method may further include, if selected filter data is received from another electronic device (similar to the electronic device 200 of FIG. 2, or the second electronic device 400B of FIG. 4), updating filter data of an object corresponding to the selected filter data.

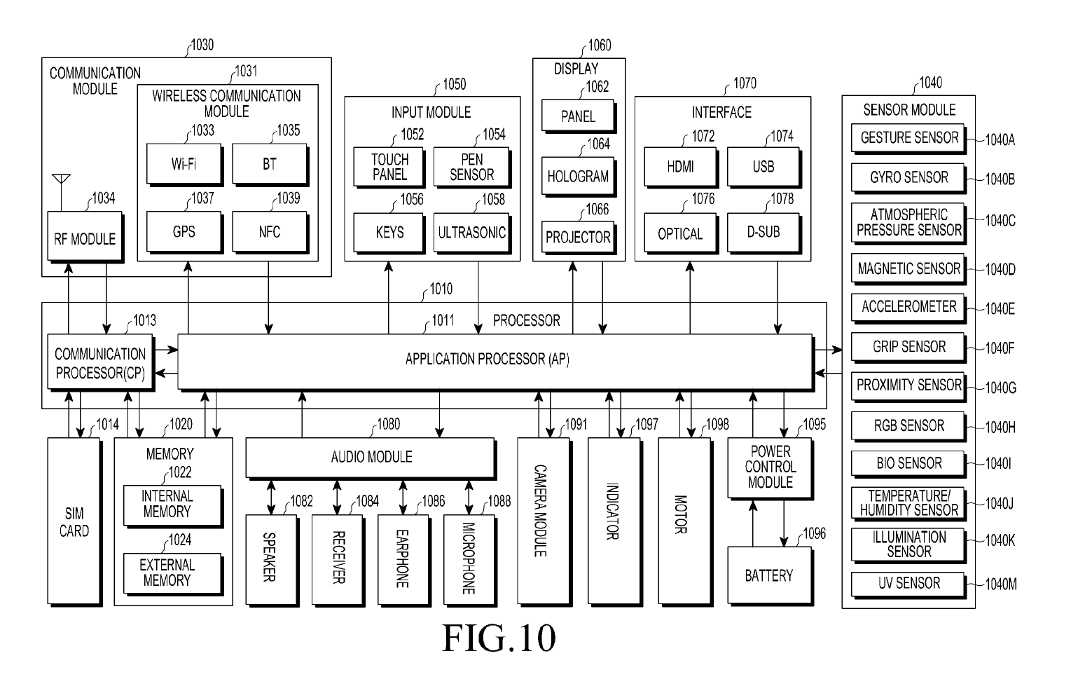

FIG. 10 is a block diagram illustrating an electronic device 1000 according to various embodiments of the present disclosure. The electronic device 1000 may constitute the whole or part of, for example, the electronic device 100 shown in FIG. 1. Referring to FIG. 10, the electronic device 1000 may include one or more processor 1010, a Subscriber Identification Module (SIM) card 1014, a memory 1020, a communication module 1030, a sensor module 1040, an input module 1050, a display 1060, an interface 1070, an audio module 1080, a camera module 1091, a power management module 1095, a battery 1096, an indicator 1097, and a motor 1098.

The processor 1010 may include one or more Application Processor (AP) 1011 and one or more Communication Processor (CP) 1013. The processor 1010 may be, for example, the processor 120 shown in FIG. 1. Although the AP 1011 and the CP 1013 are assumed to be incorporated into the processor 1010 in FIG. 10, the AP 1011 and the CP 1013 may be separately incorporated into different IC packages. According to one embodiment, AP 1011 and the CP 1013 may be incorporated into one IC package.

The AP 1011 may control a plurality of software or hardware components connected to the AP 1011 by running an operating system or an application program, and process various data including multimedia data. The AP 1011 may be implemented in, for example, a System-on-Chip (SoC). According to one embodiment, the processor 1010 may further include a Graphic Processing Unit (GPU) (not shown).

The CP 1013 may perform a function of managing a data link and converting a communication protocol in communication between the electronic device 1000 and other electronic devices (e.g., the electronic devices 102, 104, and the server 164 of FIG. 1) connected over a network. The CP 1013 may be implemented in, for example, a SoC. According to one embodiment, the CP 1013 may perform at least some multimedia control functions. The CP 1013 may perform identification and authentication of the electronic device 1000 within the communication network by using, for example, a subscriber identification module (e.g., the SIM card 1014). In addition, the CP 1013 may provide services for voice calls, video calls, text messages or packet data, to the user.

In addition, the CP 1013 may control data transmission/reception of the communication module 1030. Although components such as the CP 1013, the power management module 1095, or the memory 1020, are assumed to be separate components from the AP 1011 in FIG. 10, the AP 1011 may be implemented to include at least some (e.g., the CP 1013) of the above-described components, according to one embodiment.

According to one embodiment, the AP 1011 or the CP 1013 may load, on a volatile memory (not shown), the command or data received from at least one of a nonvolatile memory and other components connected thereto, and process the loaded command or data. In addition, the AP 1011 or the CP 1013 may store, in a nonvolatile memory (not shown), the data that is received from or generated by at least one of other components.

The SIM card 1014 may be a card in which a subscriber identification module is implemented, and may be inserted into a slot that is formed in a specific position of the electronic device 1000. The SIM card 1014 may include unique identification information (e.g., Integrated Circuit Card Identifier (ICCID)) or subscriber information (e.g., International Mobile Subscriber Identity (IMSI)).

The memory 1020 may include an internal memory 1022 or an external memory 1024. The memory 1020 may be, for example, the memory 130 shown in FIG. 1. The internal memory 1022 may include at least one of, for example, a volatile memory (e.g., dynamic random access memory (DRAM), static random access memory (SRAM), synchronous dynamic random access memory (SDRAM) and/or the like) or a nonvolatile memory (e.g., one time programmable read only memory (OTPROM), programmable read only memory (PROM), erasable and programmable read only memory (EPROM), electrically erasable and programmable read only memory (EEPROM), mask read only memory, flash read only memory, negative-AND (NAND) flash memory, negative-OR (NOR) flash memory and/or the like). According to one embodiment, the internal memory 1022 may be a Solid State Drive (SSD). The external memory 1024 may further include a flash drive (e.g., a compact flash (CF) card, a secure digital (SD) card, a micro secure digital (Micro-SD) card, a mini secure digital (Mini-SD) card, an extreme digital (xD) card, a memory stick and/or the like). The external memory 1024 may be functionally connected to the electronic device 1000 through a variety of interfaces.

Although not illustrated, the electronic device 1000 may further include a storage device (or storage medium) such as a hard drive.

The communication module 1030 may include a wireless communication module 1031, or a Radio Frequency (RF) module 1034. The communication module 1030 may be incorporated into, for example, the communication module 160 shown in FIG. 1. The wireless communication module 1031 may include, for example, WiFi 1033, BT 1035, GPS 1037, or NFC 1039. For example, the wireless communication module 1031 may provide a wireless communication function using a radio frequency. Additionally or alternatively, the wireless communication module 1031 may include a network interface (e.g., LAN card) (not shown), or a module for connecting the electronic device 1000 to a network (e.g., Internet, LAN, WAN, telecommunication network, cellular network, satellite network, POTS and/or the like).

The RF module 1034 may handle transmission/reception of voice or data signals. Although not illustrated, the RF module 1034 may include, for example, a transceiver, a Power Amp Module (PAM), a frequency filter, a Low Noise Amplifier (LNA) and/or the like. In addition, the RF module 1034 may further include parts (e.g., a conductor, a conducting wire and/or the like) for transmitting and receiving electromagnetic waves in the free space in wireless communication.

The sensor module 1040 may include at least one of, for example, a gesture sensor 1040A, a gyro sensor 1040B, a barometer or an atmospheric pressure sensor 1040C, a magnetic sensor 1040D, an accelerometer 1040E, a grip sensor 1040F, a proximity sensor 1040G, a Red-Green-Blue (RGB) sensor 1040H, a biometric (or BIO) sensor 1040I, a temperature/humidity sensor 1040J, an illuminance or illumination sensor 1040K, an Ultra-Violet (UV) sensor 1040M, and an Infra-Red (IR) sensor (not shown). The sensor module 1040 may measure the physical quantity or detect the operating status of the electronic device, and convert the measured or detected information into an electrical signal. Additionally or alternatively, the sensor module 1040 may include, for example, an E-nose sensor (not shown), an electromyography (EMG) sensor (not shown), an electroencephalogram (EEG) sensor (not shown), an electrocardiogram (ECG) sensor (not shown), a fingerprint sensor and/or the like. The sensor module 1040 may further include a control circuit for controlling at least one or more sensors belonging thereto.

The input module 1050 may include a touch panel 1052, a (digital) pen sensor 1054, a key 1056, or an ultrasonic input device 1058. The input module 1050 may be incorporated into, for example, the I/O interface 140 shown in FIG. 1. The touch panel 1052 may recognize a touch input by using at least one of, for example, a capacitive method, a resistive method, an infrared method and an ultrasonic method. In addition, the touch panel 1052 may further include a controller (not shown). When using the capacitive method, the touch panel 1052 may recognize not only the physical contact but also the proximity. The touch panel 1052 may further include a tactile layer function. In this case, the touch panel 1052 may provide a tactile feedback to the user.

The (digital) pen sensor 1054 may be implemented by using, for example, the same or similar method as receiving a user's touch input, or a separate recognition sheet. The keys 1056 may include, for example, a physical button. In addition, the keys 1056 may include, for example, an optical key, a keypad or a touch key. The ultrasonic input device 1058 is a device by which the terminal can check the data by detecting sound waves with a microphone (e.g., MIC 1088), using an input tool for generating an ultrasonic signal, and the ultrasonic input device 1058 is capable of wireless recognition. According to one embodiment, the electronic device 1000 may receive a user input from an external device (e.g., a network, a computer or a server) connected thereto, using the communication module 1030.

The display 1060 may include a panel 1062, a hologram 1064, or a projector 1066. The display 1060 may be, for example, the display 150 shown in FIG. 1. The panel 1062 may be, for example, a Liquid Crystal Display (LCD) panel, an Active-Matrix Organic Light-Emitting Diode (AM-OLED) panel, and/or the like. The panel 1062 may be implemented to be, for example, flexible, transparent or wearable. The panel 1062 may be configured as one module with the touch panel 1052. The hologram 1064 may show a three-dimensional (3D) image in the air, using light interference. The projector 1066 may show images on the external screen by projecting the light. According to one embodiment, the display 1060 may further include a control circuit (not shown) for controlling the panel 1062, the hologram 1064 or the projector 1066.

The interface 1070 may include, for example, a High Definition Multimedia Interface (HDMI) module 1072, a USB module 1074, an optical module 1076, or a D-subminiature (D-sub) module 1078. The communication module 1030 may be incorporated into, for example, the communication module 160 shown in FIG. 1. Additionally or alternatively, the interface 1070 may include, for example, Secure Digital/Multi-Media Card (SD/MMC) (not shown) or Infrared Data Association (IrDA) (not shown).

The audio module 1080 may convert sounds and electrical signals bi-directionally. The audio module 1080 may be incorporated into, for example, the I/O interface 140 shown in FIG. 1. The audio module 1080 may process the sound information that is input or output through, for example, a speaker 1082, a receiver 1084, an earphone 1086 or the MIC 1088.

The camera module 1091 is a device that can capture images or videos. According to one embodiment, the camera module 1091 may include one or more image sensors (e.g., a front sensor or a rear sensor) (not shown), a lens (not shown), an Image Signal Processor (ISP) (not shown), or a flash (not shown) (e.g., Light-Emitting Diode (LED) or a xenon lamp).

The power management module 1095 may manage the power of the electronic device 1000. Although not illustrated, the power management module 1095 may include, for example, a Power Management Integrated Circuit (PMIC), a charger Integrated Circuit (IC), or a battery or fuel gauge.

The PMIC may be mounted in, for example, an integrated circuit or a SoC semiconductor. The charging scheme may be divided into a wired charging scheme and a wireless charging scheme. The charger IC may charge a battery, and prevent the inflow of over-voltage or over-current from the charger. According to one embodiment, the charger IC may include a charger IC for at least one of the wired charging scheme and the wireless charging scheme. The wireless charging scheme may include, for example, a magnetic resonance scheme, a magnetic induction scheme, an electromagnetic scheme and/or the like, and additional circuits (e.g., a coil loop, a resonance circuit, a rectifier and/or the like) for wireless charging may be added.

A battery gauge may measure, for example, a level, a charging voltage, a charging current or a temperature of the battery 1096. The battery 1096 may store electricity to supply the power. The battery 1096 may include, for example, a rechargeable battery or a solar battery.

The indicator 1097 may indicate specific states (e.g., the boot status, message status, charging status and/or the like) of the electronic device 1000 or a part (e.g., the AP 1011) thereof. The motor 1098 may convert an electrical signal into mechanical vibrations.

Although not illustrated, the electronic device 1000 may include a processing unit (e.g., GPU) for supporting a mobile TV. The processing unit for supporting a mobile TV may process media data based on the standards such as, for example, Digital Multimedia Broadcasting (DMB), Digital Video Broadcasting (DVB), MediaFlow™ and/or the like.

The above-described components of the electronic device according to the present disclosure may each be configured with one or more components, and names of the components may vary according to the type of the electronic device. The electronic device according to the present disclosure may include at least one of the above-described components, some of which can be omitted, or may further include other additional components. In addition, some of the components of the electronic device according to the present disclosure are configured as one entity by being combined with one another, so the functions of the components, which are defined before the combination, may be performed in the same manner.

The term ‘module’ as used herein may refer to a unit that includes, for example, one of hardware, software or firmware, or a combination of two or more of them. The ‘module’ may be interchangeably used with the terms such as, for example, unit, logic, logical block, component, circuit and/or the like. The ‘module’ may be the minimum unit of integrally configured component, or a part thereof. The ‘module’ may be the minimum unit for performing one or more functions, or a part thereof. The ‘module’ may be implemented mechanically or electronically. For example, the ‘module’ according to the present disclosure may include at least one of an Application-Specific Integrated Circuit (ASIC) chip, Field-Programmable Gate Arrays (FPGAs), and a programmable-logic device for performing certain operations, which are known or to be developed in the future.

An electronic device (e.g., the electronic device 100 of FIG. 1, the electronic device 200 of FIG. 2, the electronic device 400A of FIG. 4, or the second electronic device 400B of FIG. 4) according to the present disclosure may receive and store a program including instructions for allowing the electronic device to perform the filter recommendation control method, from a program server (e.g., the server 164 of FIG. 1) that is connected to the electronic device by a wire or wirelessly, and the electronic device or the server shown in FIG. 1 may be the program server. The program server may include a memory for storing the program, a communication module for performing wired/wireless communication with the electronic device, and a processor for transmitting the program to the electronic device automatically or at the request of the electronic device.

As is apparent from the foregoing description, the electronic device according to various embodiments and the method for providing a filter in the electronic device may provide a variety of filter functions according to the types of objects included in image data.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. An electronic device comprising:
a screen of a display;
an image sensor configured to capture image data having at least one object; and
a filter recommendation control module configured to acquire the image data captured by the image sensor, extract at least one filter data based on the at least one object of the image data, and display the at least one filter data on the screen in response to request information.

2. The electronic device of claim 1, wherein the image data includes at least one of shooting information and object information,
wherein the shooting information includes at least one of a shooting location, a shooting weather, a shooting date, and a shooting time;
wherein the object information includes at least one of a type of the at least one object, a location of the at least one object, a proportion of the at least one object, and a sharpness of the at least one object; and
wherein the object information is configured to be present to correspond to a number of the at least one object of the image data.

3. The electronic device of claim 1, wherein the filter recommendation control module is further configured to extract the at least one object from the image data by defining an area.

4. The electronic device of claim 1, wherein the filter recommendation control module is further configured to extract a shooting location based on shooting information of the image data, and extract at least one filter data corresponding to at least one of a shooting location and classification information of the at least one object, from a stored filter database (DB),
wherein the filter recommendation control module is further configured to determine the classification information of the at least one object for each of at least one object of the image data depending on at least one of a priority of a location of the at least one object, a proportion of the at least one object, and a sharpness of the at least one object.

5. The electronic device of claim 1, wherein the filter recommendation control module is further configured to, if at least one filter data is selected while displaying at least one filter data, apply a filter function corresponding to the at least one filter data to each of the at least one object, and update the at least one filter data of the at least one object corresponding to the selected at least one filter data.

6. The electronic device of claim 1, wherein the filter recommendation control module is further configured to extract at least one of shooting information and object information from the image data as filter data request information, transmit the extracted filter data request information to another electronic device, provide at least one filter data received from another electronic device as at least one filter information for each of the at least one object included in the image data, and transmit filter data of the at least one object corresponding to selected filter data to another electronic device.

7. An electronic device comprising:
a storage module storing at least one filter data corresponding to filter data request information including at least one of shooting information and object information; and
a filter recommendation control module configured to, if the filter data request information is received from another electronic device, extract the at least one filter data based on the at least one of shooting information and object information included in the at least one filter data, and transmit the extracted at least one filter data to another electronic device.

8. The electronic device of claim 7, further comprising an image sensor configured to capture image data including at least one object, and wherein the filter recommendation control module is further configured to:
extract classification information for the at least one object included in the image data based on the object information;
extract a shooting location based on the shooting information; and
extract at least one filter data corresponding to at least one of a shooting location and classification information of the at least one object, from a stored filter database (DB).

9. The electronic device of claim 8, wherein the filter recommendation control module is further configured to determine classification information of each of the at least one object included in the image data depending on at least one of a priority of a location of the at least one object, a proportion of the at least one object, and a sharpness of the at least one object.

10. The electronic device of claim 8, wherein the filter recommendation control module is further configured to, if selected filter data is received from another electronic device, update filter data of the at least one object corresponding to the selected filter data.

11. A method for providing a filter in an electronic device having a screen of a display and an image sensor configured to capture an image data including at least one object, the method comprising:
acquiring the image data captured by an image sensor;
extracting at least one filter data based on the at least one object of the image data; and
displaying the at least one filter data on the screen in response to request information.

12. The method of claim 11, wherein the image data includes at least one of shooting information and object information,
wherein the shooting information includes at least one of a shooting location, a shooting weather, a shooting date, and a shooting time,
wherein the object information includes at least one of a type of the at least one object, a location of the at least one object, a proportion of the at least one object, and a sharpness of the at least one object; and
wherein the object information is configured to be present to correspond to the number of at least one object included in the image data.

13. The method of claim 11, wherein the extracting at least one filter data comprises extracting the at least one object from the image data by defining an area.

14. The method of claim 1, wherein the image data includes shooting information, wherein the extracting at least one filter data comprises:
extracting a shooting location based on the shooting information of the image data; and
extracting at least one filter data corresponding to at least one of a shooting location and classification information of the at least one object, from a stored filter database (DB),
wherein the extracting at least one filter data corresponding to classification information comprises determining the classification information of each of the at least one object included in the image data depending on at least one of a priority of a location of the at least one object, a proportion of the at least one object, and a sharpness of the at least one object.

15. The method of claim 11, further comprising, if at least one filter data is selected while displaying at least one filter data, applying a filter function corresponding to at least one filter data to each of the at least one object, and updating filter data of an object corresponding to the selected at least one filter data.

16. The method of claim 11, wherein the image data further includes at least one of shooting information and object information, the method further comprising:
extracting at least one of the shooting information and the object information from the image data as filter data request information and transmitting the extracted filter data request information to another electronic device;
providing at least one filter data received from another electronic device as at least one filter information for each of the at least one object included in the image data; and
transmitting of the at least one filter data of the at least one object corresponding to selected filter data to another electronic device.

17. A method for providing a filter in an electronic device, the method comprising:
storing at least one filter data corresponding to filter data request information including at least one of shooting information and object information; and
if at least one filter data request information is received from another electronic device, extracting at least one filter data based on at least one of shooting information and object information included in at least one filter data, and transmitting the extracted at least one filter data to another electronic device.

18. The method of claim 17, wherein the extracting at least one filter data comprises:
extracting classification information for each of at least one object included in image data based on the object information;
extracting a shooting location based on the shooting information; and
extracting at least one filter data corresponding to at least one of a shooting location and classification information of the at least one object, from a stored filter database (DB).

19. The method of claim 18, wherein the extracting classification information comprises determining the classification information of each of at least one object included in the image data depending on at least one of a priority of a location of the at least one object, a proportion of the at least one object, and a sharpness of the at least one object.

20. The method of claim 17, further comprising, if selected filter data is received from another electronic device, updating filter data of an object corresponding to the selected filter data.
